(19) United States
(12) Patent Application Publication
(10) Pub. No.: US 2024/0195591 A1
(43) Pub. Date: Jun. 13, 2024

(54) SUPPORT OF PUCCH TRANSMISSIONS FOR REDUCED-BANDWIDTH USER EQUIPMENTS

(71) Applicant: TELEFONAKTIEBOLAGET LM ERICSSON (PUBL), STOCKHOLM (SE)

(72) Inventors: Mohammad Mozaffari, FREMONT, CA (US); Yi-Pin Eric Wang, FREMONT, CA (US)

(21) Appl. No.: 18/286,091

(22) PCT Filed: Apr. 6, 2022
(86) PCT No.: PCT/IB2022/053249

§ 371 Date: Oct. 6, 2023

Related U.S. Application Data
(60) Provisional application No. 63/171,505, filed on Apr. 6, 2021.

(51) Int. Cl. H04L 5/00; H04W 72/0457; H04W 72/21

(52) U.S. Cl. CPC H04L 5/0094; H04L 5/0012; H04W 72/0457; H04W 72/21

(57) ABSTRACT

Systems, devices and methods are described that support of physical uplink control channel (PUCCH) transmissions for reduced-bandwidth user equipments (UEs). One method performed by a UE includes receiving configuration information to be utilized to communicate with a base station, the configuration information including information indicating whether frequency hopping, associated with transmission of control information via PUCCH, is enabled or disabled; and transmitting control information via the PUCCH based on whether the frequency hopping is enabled or disabled. Other methods, devices, and systems for supporting PUCCH transmission for reduced-bandwidth UEs are included.

### RELATED APPLICATIONS

This application claims the benefit of U.S. Provisional Patent Application No. 63/171,505, filed Apr. 6, 2021, the disclosure of which is hereby incorporated herein by reference in its entirety.

### TECHNICAL FIELD

The present disclosure relates to uplink transmissions in a cellular communications system.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some aspects, a reduced-bandwidth UE may be a wireless device that is configured with an operating bandwidth that is smaller than an operating bandwidth configured for a regular/legacy UE. Some examples of reduced-bandwidth UEs are discussed below.

The next paradigm shift in processing and manufacturing is the Industry 4.0 in which factories are automated and made much more flexible and dynamic with the help of wireless connectivity. This includes real-time control of robots and machines using time-critical machine-type communication (cMTC) and improved observability, control, and error detection with the help of large numbers of more simple actuators and sensors (massive machine-type communication or mMTC). For cMTC support, URLLC was introduced in 3GPP Release 15 for both LTE and NR, and NR URLLC is further enhanced in Release 16 within the enhanced URLLC (eURLLC) and Industrial IoT work items.

For mMTC and low power wide area (LPWA) support, 3GPP introduced both narrowband Internet-of-Things (NB-IOT) and long-term evolution for machine-type communication (LTE-MTC, or LTE-M) in Release 13. These technologies have been further enhanced through all releases up until and including the ongoing Release 16 work.

NR (New Radio) was introduced in 3GPP Release 15 and focused mainly on the enhanced mobile broadband (eMBB) and cMTC. However, there are still several other use cases whose requirements are higher than LPWAN (i.e., LTEM/NB-IOT) but lower than URLLC and eMBB [1]. In order to efficiently support such use cases which are in-between eMBB, URLLC, and mMTC, the 3GPP has studied reduced capability NR devices (NR-RedCap) in Release 17 [2]. The RedCap as a study item has been completed and is going to continue as a work item [1]. The NR-RedCap user equipments (UEs) are designed to have lower cost, lower complexity, a longer battery life, and enable a smaller form factor than legacy NR UEs. For RedCap UEs, different complexity reduction features including the reduced bandwidth and reduced number of antennas have been considered.

According to Release 15 and 16 NR specifications, a UE is required to support 100 MHz in FR1 and 200 MHz in FR2. These bandwidth requirements are considerably higher than what is needed from the data rate requirements of the RedCap use cases. Therefore, in study item reduced bandwidth options including 20 MHz in FR1 and 50 MHz or 100 MHz in FR2 were studied. According to the new work item, it is required to specify support for the following reduced maximum UE bandwidth features [RAN1, RAN4]:
Maximum bandwidth of an FR1 RedCap UE during and after initial access of 20 MHz is supported.
Maximum bandwidth of an FR2 RedCap UE during and after initial access is 100 MHz.

For support of different UEs with different capabilities (e.g., different bandwidths) in a network, it is important to ensure an efficient coexistence of the different UEs while considering resource utilization, network spectral/energy efficiency, and scheduling complexity. In this regard, it is beneficial to have the shared initial DL and initial UL BWPs between different UEs particularly to avoid resource fragmentation and improve resource efficiency. For example, it is desired to support shared initial BWPs (which are used for initial access) between reduced-bandwidth UEs (e.g., RedCap UEs) and legacy UEs (e.g., regular UEs).

The first step in initial access is that a UE detects the DL synchronization reference signals, including primary synchronization signal (PSS) and secondary synchronization signal (SSS). Following that, the UE reads the physical broadcast channel (PBCH) which includes master information block (MIB). Among other information, MIB contains PDCCH-ConfigSIB1, which is the configuration of CORESET #0. After decoding CORESET0 which is the DL assignment for the remaining system information, the UE can receive the SIB1, which includes the random access channel (RACH) configuration.

Random access is the procedure of UE accessing a cell, receiving a unique identification by the cell and receiving the basic radio resource configurations. The steps of a four-step random access procedure may include:
UE transmits a preamble referred to as Physical random access channel (PRACH)
Networks sends random access response (RAR), indicating reception of preamble and providing time-alignment command
UE sends a PUSCH, a.k.a., Message 3, aiming at resolving collision
Network sends the contention resolution message, a.k.a., Message 4
UE sends the ACK/NACK for Msg4 on the physical uplink control channel (PUCCH).

In general, PUCCH is used by the device for carrying uplink control information (UCI) for various purposes such as HARQ feedback, CSI (Channel State Information) and SR (Scheduling Request). NR supports five different PUCCH formats (i.e., Formats 0-4). PUCCH formats 0 and 2, which are known as short formats, occupy 1 or 2 OFDM symbols. PUCCH formats 1, 3, and 4 are known as long formats which occupy 4 to 14 OFDM symbols. Moreover, frequency hopping is supported for long PUCCH formats and for short PUCCH formats of duration two symbols.

Before a dedicated RRC connection (i.e., during random/initial access), the PUCCH configuration is done in PUCCH-ConfigCommon (shown in Table 1) from SIB1. The information element (IE) PUCCH-ConfigCommon is used to configure the cell specific PUCCH parameters.

TABLE 1
PUCCH-ConfigCommon information element
Error! Reference source not found.

| PUCCH-ConfigCommon ::= | SEQUENCE { |
|---|---|
| pucch-ResourceCommon | INTEGER (0..15) |
| OPTIONAL, -- Cond InitialBWP-Only | |
| pucch-GroupHopping | ENUMERATED {neither, enable, disable}, |
| hoppingId | INTEGER (0..1023) |
| OPTIONAL, -- Need R | |
| p0-nominal | INTEGER (−202..24) |

OPTIONAL, -- Need R
...
}

pucch-ResourceCommon is an entry into a 16-row table where each row configures a set of cell-specific PUCCH resources/parameters. The UE uses those PUCCH resources until it is provided with a dedicated PUCCH-Config (e.g., during initial access) on the initial uplink BWP.

Such PUCCH configuration in PUCCH-ConfigCommon only supports short Format 0 with two symbols and long Format 1 with 4, 10, and 14 symbols. Also, in this configuration frequency hopping is always applied/enabled. Therefore, for PUCCH transmissions for Msg4 (four-step RACH) or MsgB (two-step RACH) HARQ feedback during the random access procedure, the frequency hopping within a slot (intra-slot frequency hopping) is always enabled. In FIG. 1, we show an example of PUCCH configuration with intra-slot frequency hopping enabled.

In this regard, in 3GPP RAN1 #104, the following options were mentioned to enable/support that PUCCH (for Msg4/[MsgB] HARQ feedback) and/or PUSCH (for Msg3/[MsgA]) transmissions fall within the RedCap UE bandwidth:
Option 1: Proper RF-retuning for RedCap (if feasible)
Option 2: Separate initial UL BWP(s) for RedCap
Option 3: Separate PUCCH/Msg3/[MsgA] PUSCH configuration/indication or a different interpretation for the same configuration/indication for RedCap (e.g., disabled frequency hopping or different frequency hopping)
Option 4: gNB configuration (e.g., always restricting the initial UL BWP to within RedCap UE bandwidth, or restrictions on the frequency location and the amount of scheduled resource for Msg4/[MsgB] HARQ feedback and Msg3/[MsgA] PUSCH)

### SUMMARY

One general aspect of the present disclosure is a method performed by a wireless device, the method including: receiving configuration information to be utilized to communicate with a base station, the configuration information including information indicating whether frequency hopping, associated with transmission of control information via a physical uplink control channel (PUCCH), is enabled or disabled; and transmitting control information via the PUCCH based on whether the frequency hopping is enabled or disabled.

Some implementations of the method include: The method wherein an information element included in a system information block of the configuration information indicates whether frequency hopping is enabled or disabled. The method wherein receiving the configuration information, including the information indicating whether frequency hopping is enabled or disabled, includes receiving the configuration information dynamically. The method further including: transmitting the control information via the PUCCH by utilizing the frequency hopping when the frequency hopping is enabled; and transmitting the control information via the PUCCH without utilizing the frequency hopping when the frequency hopping is disabled.

Another general aspect of the present disclosure is a method performed by a wireless device, the method including: receiving configuration information to be utilized to communicate with a base station, the configuration information including information indicating a first size or a first location associated with a first initial bandwidth part (BWP) configured for the wireless device and a second size or a second location associated with a second initial BWP configured for another wireless device; and transmitting, by selectively utilizing frequency hopping, control information via a physical uplink control channel (PUCCH) based on the first size of the first initial BWP and the second size of the second initial BWP or based on the first location of the first initial BWP and the second location of the second initial BWP.

Some implementations of the method include: The method wherein the wireless device transmits the control information via the PUCCH by utilizing the frequency hopping when the first size and the second size are substantially the same. The method wherein the wireless device transmits the control information via the PUCCH without utilizing the frequency hopping when the first size and the second size are different. The method wherein the wireless device transmits the control information via the PUCCH without utilizing the frequency hopping when the first initial BWP is located within the second initial BWP. The method wherein whether the frequency hopping is enabled or disabled is based on a presence of another wireless device in a cell associated with the base station. The method further including: providing user data; and forwarding the user data to a host computer via the transmission to the base station.

Another general aspect of the present disclosure is a method performed by a base station, the method including: transmitting configuration information to be utilized by a wireless device to communicate with the base station, the configuration information including information indicating whether frequency hopping, associated with transmission of control information via a physical uplink control channel (PUCCH), is enabled or disabled; and receiving control information via the PUCCH based on whether the frequency hopping is enabled or disabled.

Some implementations of the method include: The method wherein an information element included in the system information block of the configuration information indicates whether the frequency hopping is enabled or disabled. The method wherein transmitting the configuration information, including the information indicating whether the frequency hopping is enabled or disabled, includes transmitting the configuration information dynamically. The method further including: obtaining user data; and forwarding the user data to a host computer or a wireless device.

Another general aspect of the present disclosure is a wireless device including: processing circuitry configured to perform any of the steps of any of method described herein and power supply circuitry configured to supply power to the wireless device.

Another general aspect of the present disclosure is a base station for, the base station including: processing circuitry configured to perform any of the steps of any method described herein and power supply circuitry configured to supply power to the wireless device.

Another general aspect of the present disclosure is a user equipment (UE) for, the UE including: an antenna configured to send and receive wireless signals; radio front-end circuitry connected to the antenna and to processing circuitry, and configured to condition signals communicated between the antenna and the processing circuitry, the processing circuitry being configured to perform any of the steps of any method described herein; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Another general aspect of the present disclosure is a communication system including a host computer including: processing circuitry configured to provide user data; and a communication interface configured to forward the user data to a cellular network for transmission to a user equipment (UE), wherein the cellular network includes a base station having a radio interface and processing circuitry, the base station's processing circuitry configured to perform any of the steps of any of method described herein.

Some implementations of the communication system include: The communication system further including the base station. The communication system further including the UE, wherein the UE is configured to communicate with the base station. The communication system wherein: the processing circuitry of the host computer is configured to execute a host application, thereby providing the user data; and the UE includes processing circuitry configured to execute a client application associated with the host application.

Another general aspect of the present disclosure is a method implemented in a communication system including a host computer, a base station and a user equipment (UE), the method including: at the host computer, providing user data; and at the host computer, initiating a transmission carrying the user data to the UE via a cellular network including the base station, wherein the base station performs any of the steps of any method described herein.

Some implementations of the method include: The method further including, at the base station, transmitting the user data. The method wherein the user data is provided at the host computer by executing a host application, the method further including, at the UE, executing a client application associated with the host application.

Another general aspect of the present disclosure is a user equipment (UE) configured to communicate with a base station, the UE including a radio interface and processing circuitry configured to performs the steps of any method described herein.

Another general aspect of the present disclosure is a communication system including a host computer including: processing circuitry configured to provide user data; and a communication interface configured to forward user data to a cellular network for transmission to a user equipment (UE), wherein the UE includes a radio interface and processing circuitry, the UE's components configured to perform any of the steps of any method described herein.

Some implementations of the communication system include: The communication system wherein the cellular network further includes a base station configured to communicate with the UE. The communication system wherein the processing circuitry of the host computer is configured to execute a host application, thereby providing the user data; and the UE's processing circuitry is configured to execute a client application associated with the host application.

Another general aspect of the present disclosure is a method implemented in a communication system including a host computer, a base station and a user equipment (UE), the method including: at the host computer, providing user data; and at the host computer, initiating a transmission carrying the user data to the UE via a cellular network including the base station, wherein the UE performs any of the steps of any method described herein.

Some implementations of the method include: The method further including at the UE, receiving the user data from the base station.

Another general aspect of the present disclosure is a communication system including a host computer including: communication interface configured to receive user data originating from a transmission from a user equipment (UE) to a base station, wherein the UE includes a radio interface and processing circuitry, the UE's processing circuitry configured to perform any of the steps of any method described herein.

Some implementations of the communication system include: The communication system further including the UE. The communication system further including the base station, wherein the base station includes a radio interface configured to communicate with the UE and a communication interface configured to forward to the host computer the user data carried by a transmission from the UE to the base station. The communication system wherein the processing circuitry of the host computer is configured to execute a host application; and the UE's processing circuitry is configured to execute a client application associated with the host application, thereby providing the user data. The communication system wherein the processing circuitry of the host computer is configured to execute a host application, thereby providing request data; and the UE's processing circuitry is configured to execute a client application associated with the host application, thereby providing the user data in response to the request data.

Another general aspect of the present disclosure is a method implemented in a communication system including a host computer, a base station and a user equipment (UE), the method including: at the host computer, receiving user data transmitted to the base station from the UE, wherein the UE performs any of the steps of method described herein.

Some implementations of the method include: The method further including, at the UE, providing the user data to the base station. The method further including: at the UE, executing a client application, thereby providing the user data to be transmitted; and at the host computer, executing a host application associated with the client application. The method further including: at the UE, executing a client application; and at the UE, receiving input data to the client application, the input data being provided at the host computer by executing a host application associated with the client application, wherein the user data to be transmitted is provided by the client application in response to the input data.

Another general aspect of the present disclosure is a communication system including a host computer including a communication interface configured to receive user data originating from a transmission from a user equipment (UE) to a base station, wherein the base station includes a radio interface and processing circuitry, the base station's processing circuitry configured to perform any of the steps of any method described herein.

Some implementations of the communication system include: The communication system further including the base station. The communication system further including the UE, wherein the UE is configured to communicate with the base station. The communication system wherein the processing circuitry of the host computer is configured to execute a host application; and the UE is configured to execute a client application associated with the host application, thereby providing the user data to be received by the host computer.

Another general aspect of the present disclosure is a method implemented in a communication system including a host computer, a base station and a user equipment (UE), the method including: at the host computer, receiving, from the base station, user data originating from a transmission which the base station has received from the UE, wherein the UE performs any of the steps of any method described herein.

Some implementations of the method include: The method further including at the base station, receiving the user data from the UE. The method further including at the base station, initiating a transmission of the received user data to the host computer

### BRIEF DESCRIPTION OF THE DRAWINGS

The present disclosure includes the following figures:

FIG. 1 depicts an example associated with support of PUCCH transmissions for reduced-bandwidth user equipments (UEs).

FIG. 2 depicts an example associated with support of PUCCH transmissions for reduced-bandwidth UEs.

FIG. 3 depicts an example associated with support of PUCCH transmissions for reduced-bandwidth UEs.

FIG. 4 depicts an example associated with support of PUCCH transmissions for reduced-bandwidth UEs.

FIG. 5 depicts an example associated with support of PUCCH transmissions for reduced-bandwidth UEs.

FIG. 6 depicts a wireless network in accordance with some embodiments.

FIG. 7 depicts a user equipment in accordance with some embodiments.

FIG. 8 depicts a virtualization environment in accordance with some embodiments.

FIG. 9 depicts a network connected via an intermediate network to a host computer in accordance with some embodiments.

FIG. 10 depicts a host computer communicating via a base station with a user equipment over a partially wireless connection in accordance with some embodiments.

FIG. 11 depicts a flowchart of a method implemented in a communication system including a host computer, a base station and a user equipment in accordance with some embodiments.

FIG. 12 depicts a flowchart of a method implemented in a communication system including a host computer, a base station and a user equipment in accordance with some embodiments.

FIG. 13 depicts a flowchart of a method implemented in a communication system including a host computer, a base station and a user equipment in accordance with some embodiments.

FIG. 14 depicts a flowchart of a method implemented in a communication system including a host computer, a base station and a user equipment in accordance with some embodiments.

FIG. 15 depicts a flowchart of a method implemented by a wireless device in accordance with some embodiments.

FIG. 16 depicts a flowchart of a method implemented by a wireless device in accordance with some embodiments.

FIG. 17 depicts a flowchart of a method implemented by a network node in accordance with some embodiments.

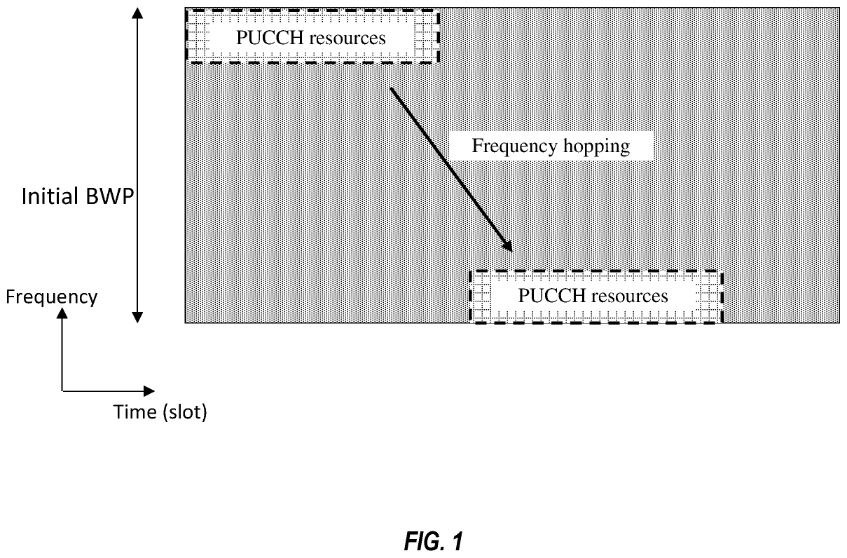

These figures will be better understood by reference to the following.

### DETAILED DESCRIPTION

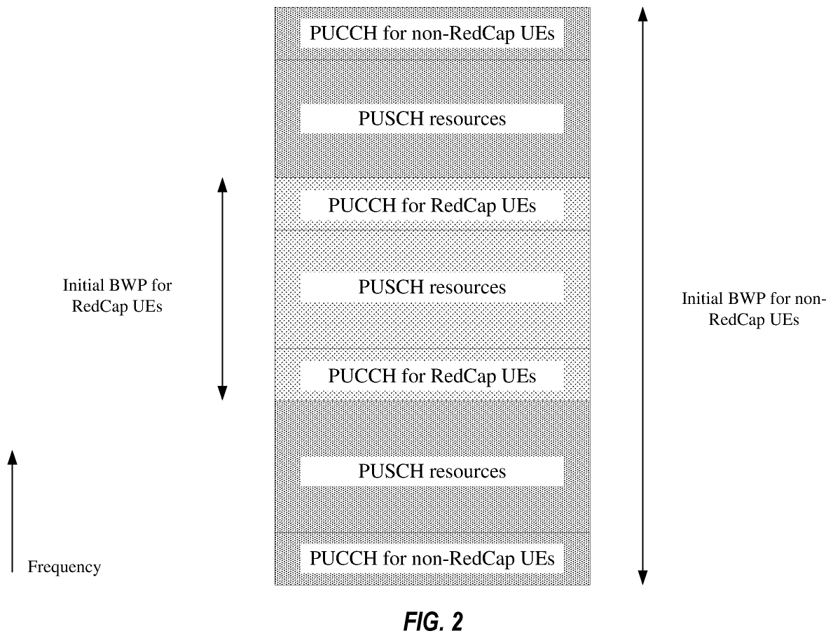

In support of the different UEs with different bandwidths, configuring different/separate PUCCH configurations and/or different/separate initial bandwidth part (BWP) for different UEs can result in resource fragmentation, thus degrading the spectral efficiency. Meanwhile, sharing the initial UL BWP between different UEs with different BW capabilities can pose few challenges as the initial BWP may be configured up to the entire carrier bandwidth. One of the key issues that needs to be addressed is related to PUCCH transmissions for Msg4 (four-step RACH) or MsgB (two-step RACH) HARQ feedback during the random access procedure. Specifically, when frequency hopping is enabled for PUCCH in the initial UL BWP, the PRBs used for PUCCH are determined based on the initial UL BWP configuration, which may have a bandwidth larger than the maximum UE bandwidth. In some aspects, the PRBs used for PUCCH are allocated to be at edges (e.g., high edge, low edge, etc.) of the initial BWP configured for a UE (e.g., RedCap UE or non-RedCap UE). In this case, it is important to enable/support PUCCH (for Msg4/[MsgB] HARQ feedback) transmissions to fall within the UE bandwidth. Therefore, proper support of PUCCH transmissions is needed to ensure efficient coexistence between UEs with different capabilities and avoid resource fragmentation. As an illustrative example, FIG. 2 shows the possibility of resource fragmentation when configuring different PUCCH resources for RedCap UEs and non-RedCap UEs (i.e., regular UEs). As shown in FIG. 2, with the different resources allocated to PUCCH for supporting non-RedCap UEs and RedCap UEs, the remaining available resources for PUSCH are fragmented to 3 non-contiguous frequency-domain resources. This prevents these available non-contiguous PUSCH resources from being used for serving a given UE when, for example, DFT-S-OFDM is used for PUSCH, because DFT-S-OFDM requires contiguous frequency-domain resource allocation. Thus, the gNB may not be able to utilize the available non-contiguous PUSCH resources to schedule the given UE at a same time, for example, when the given UE is associated with a given beam direction in a symbol or slot interval and may require the entire bandwidth provided together by the non-contiguous PUSCH resources to transmit data.

Certain aspects of the present disclosure and their embodiments may provide solutions to these or other challenges.

This disclosure contemplates solutions for supporting PUCCH transmissions of reduced bandwidth UEs (e.g., reduced capability UEs or RedCap UEs) to efficiently coexist with legacy/regular UEs in a network. Specifically, the solutions specify proper signaling methods to ensure that PUCCH (for Msg4/[MsgB] HARQ feedback) transmissions for different UEs do not cause resource fragmentation. Moreover, this disclosure contemplates effective rules for efficiently enabling and disabling PUCCH frequency hopping in various scenarios.

Some aspects include:
1) Supporting PUCCH transmissions of reduced bandwidth UEs to efficiently coexist with regular UEs in a network.
2) Signaling aspects for efficient PUCCH transmissions of reduced bandwidth.
3) Effective rules for enabling and disabling PUCCH frequency hopping.
4) Preventing resource fragmentation in supporting UEs with different capabilities (e.g., bandwidths).

There are, proposed herein, various embodiments which address one or more of the issues disclosed herein. Certain embodiments may provide one or more of the following technical advantage(s). Supporting PUCCH transmissions of reduced bandwidth UEs to efficiently coexist with regular UEs in a network. The solutions can be beneficial for: 1) efficient support of UEs with different capabilities in a network, 2) providing effective rules for efficiently enabling and disabling PUCCH frequency hopping, and/or 3) enabling efficient resource utilization, avoiding resource fragmentation, enabling scheduling flexibility, and efficient utilization of network bandwidth/capacity.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Here, as a non-limiting example of UEs with different bandwidths, we consider RedCap UEs and non-RedCap UEs (e.g., legacy UEs or regular UEs). As previously discussed, because RedCap UEs may utilize PRBs located at edges (e.g., high edge, low edge, etc.) of an initial BWP configured for RedCap UEs for PUCCH frequency hopping, the PUCCH frequency hopping can cause PUSCH resource fragmentation when coexisting with non-RedCap UEs. One way to avoid the resource fragmentation is to properly disable PUCCH frequency hopping for RedCap UEs. Therefore, there is a need for proper rules and signaling for enabling and disabling the PUCCH frequency hopping.

The common PUCCH configurations are specified in PUCCH-ConfigCommon information element (IE) which is used to configure the cell specific PUCCH parameters. More specifically, the configuration steps are as follows (TS 38.331 [4]):
1. Reading SIB1 (SIB1 and potentially other SIBs)
2. servingCellConfigCommonSIB within SIB1
3. UplinkConfigCommonSIB within servingCellConfigCommonSIB
4. BWP-UplinkCommon within servingCellConfigCommonSIB
5. PUCCH-ConfigCommon within BWP-UplinkCommon

Also, the IEs within PUCCH-ConfigCommon are given below:

PUCCH-ConfigCommon information element

| -- ASN1START | |
|---|---|
| -- TAG-PUCCH-CONFIGCOMMON-START | |
| PUCCH-ConfigCommon ::= | SEQUENCE { |
| pucch-ResourceCommon | INTEGER (0..15) |
| OPTIONAL, -- Cond InitialBWP-Only | |
| pucch-GroupHopping | ENUMERATED { neither, enable, disable }, |
| hoppingId | INTEGER (0..1023) |
| OPTIONAL, -- Need R | |
| p0-nominal | INTEGER (−202..24) |

OPTIONAL, -- Need R
...
}

where in the above IEs, pucch-ResourceCommon indicates an entry into a 16-row table where each row configures a set of cell-specific PUCCH resources/parameters. The UE uses those PUCCH resources until it is provided with a dedicated PUCCH-Config (e.g., during initial access) on the initial uplink BWP. Note that for legacy NR UEs the intra-slot frequency hopping is always enabled for PUCCH during the initial access.

In aspects of this disclosure, signaling support and rules for enabling and disabling PUCCH frequency hopping are discussed.

In one embodiment, the present disclosure contemplates a new information element (IE) in a system information block (SIB) that indicates whether PUCCH frequency hopping is disabled. In general, information about RedCap PUCCH configurations and frequency hopping can be provided via a SIB for RedCap UEs. In some aspects, when the PUCCH frequency hopping is disabled, the RedCap UE may utilize PRBs located at a given edge of the initial BWP (as opposed to utilizing PRBs located at multiple edges (e.g., high edge, low edge, etc.) of the initial BWP).

For example, the new information element FrequencyHopping-RedCap can be added in PUCCH-ConfigCommon to indicate whether the PUCCH frequency hopping for RedCap UEs is enabled or disabled. This IE can take example values 0 (disabled frequency hopping) or 1 (enabled frequency hopping). For instance, as shown below, INTEGER (0,1) or ENUMERATED {enable, disable} can be considered for Hopping-RedCap.

If PUCCH-ConfigCommon is shared with RedCap and non-RedCap UEs, the non-RedCap UEs can ignore this new element (e.g., FrequencyHopping-RedCap). In this case, the RedCap UEs can use the same PUCCH configuration as non-RedCap UEs but with the intra-slot frequency hopping disabled.

PUCCH-Config Common with frequency hopping information element

| | |
|---|---|
| PUCCH-ConfigCommon ::= | SEQUENCE { |

FrequencyHopping-RedCap INTEGER (0,1) or ENUMERATED {enable, disable}
OPTIONAL, -- Cond InitialBWP-Only

| | |
|---|---|
| pucch-ResourceCommon | INTEGER (0..15) |

OPTIONAL, -- Cond InitialBWP-Only

| | |
|---|---|
| pucch-GroupHopping | ENUMERATED { neither, enable, disable }, |
| hoppingId | INTEGER (0..1023) |

OPTIONAL, -- Need R

| | |
|---|---|
| p0-nominal | INTEGER (−202..24) |

OPTIONAL, -- Need R
...
}

In one embodiment, the PUCCH intra-slot frequency hopping is always disabled for RedCap UEs. For example, when the initial uplink BWP is shared between RedCap and non-RedCap UEs and the initial uplink BWP is wider than the RedCap UE bandwidth, frequency hopping does not need to be supported for RedCap UEs. In another example, when RedCap UEs use a separate initial uplink BWP that is smaller than the non-RedCap initial uplink BWP, the frequency hopping is disabled for RedCap UEs to avoid resource fragmentation.

In another embodiment, the PUCCH intra-slot frequency hopping for RedCap UEs is enabled or disabled based on a rule associated with whether the PUCCH frequency hopping causes PUSCH resource fragmentation. This can be determined based on the parameters of initial uplink BWPs for RedCap UEs and non-RedCap UEs. For instance, depending on sizes of and/or positions of the BWPs, the PUCCH frequency hopping can be enabled or disabled for RedCap UEs. Additionally, a RedCap UE knows how the BWPs for non-RedCap UEs and RedCap UEs are configured and determines whether it can perform the PUCCH frequency hopping. For instance, when the RedCap UE determines that PUCCH frequency hopping may result in PUSCH resource fragmentation, the RedCap UE may refrain from performing PUCCH frequency hopping.

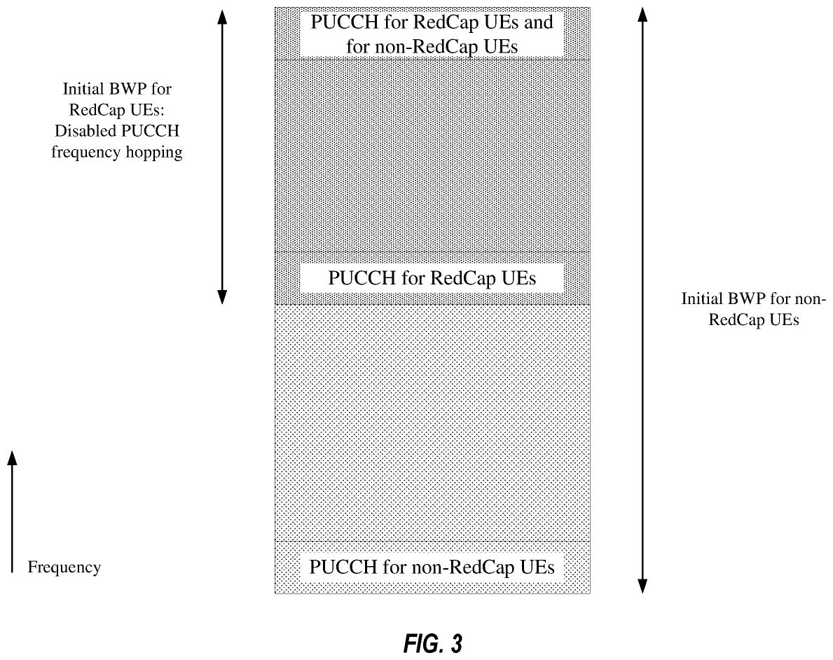

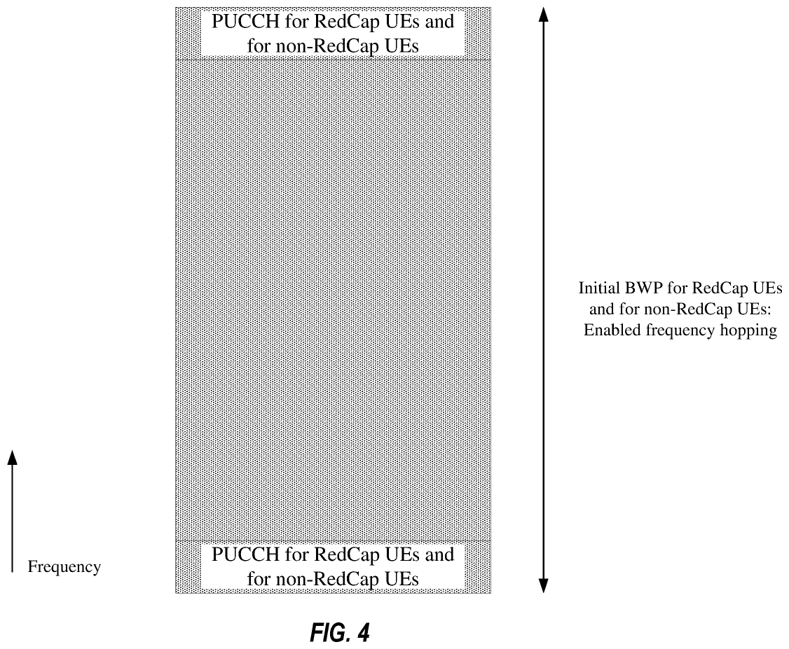

FIG. 3 shows an example of disabled PUCCH frequency hopping for RedCap UEs based on a location and/or a size of RedCap initial BWPs and non-RedCap initial BWPs. As we can see in FIG. 3, enabling the RedCap PUCCH frequency hopping can cause PUSCH resource fragmentation. FIG. 4 shows an example of enabled PUCCH frequency hopping for RedCap UEs in cases where RedCap UEs and non-RedCap UEs use substantially the same and/or substantially similar initial BWP parameters and/or configurations (e.g., sizes of the respective initial BWPs). In this example, RedCap UEs can employ the PUCCH frequency hopping without causing any resource fragmentation because the PRBs used for PUCCH frequency hopping are located at the edge areas of the initial BWP configured for the RedCap UEs and for the non-RedCap UEs. PUCCH frequency hopping is feasible for RedCap UEs with a configuration illustrated in FIG. 4, when the initial BWP bandwidth is no greater than the RedCap UE maximum bandwidth.

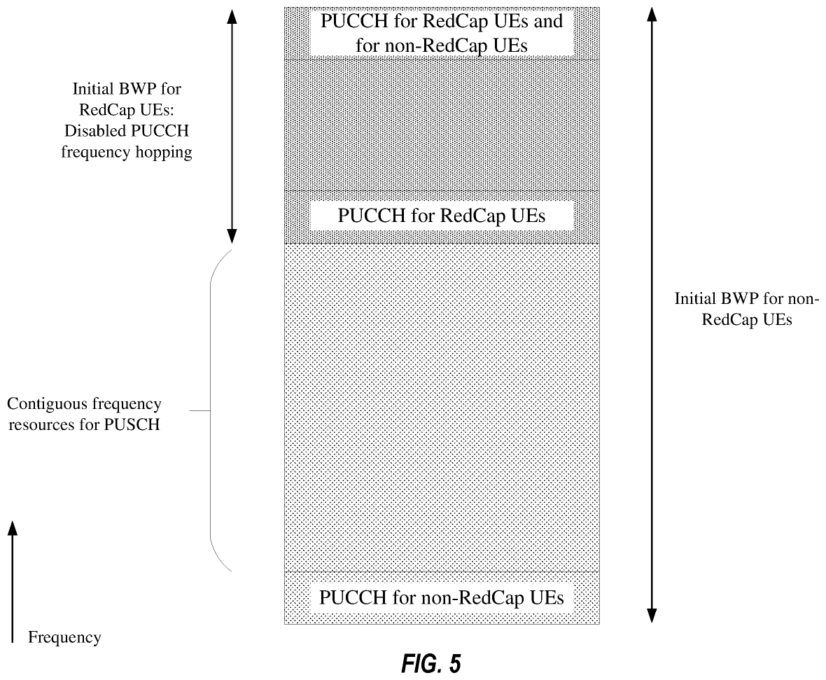

In another embodiment, the rule of enabling/disabling RedCap PUCCH frequency hopping may be based on the PUCCH configuration of non-RedCap UEs. For example, given the time-frequency resources used for non-RedCap PUCCH in a cell, the frequency hopping for RedCap PUCCH may be disabled if the frequency hopping may cause PUSCH resource fragmentation. Alternatively, the PUCCH frequency hopping may be enabled if the PUCCH frequency hopping may not result in the resource fragmentation. Meanwhile, the RedCap PUCCH can still be enabled if the potential PUSCH resource fragmentation is not significant (e.g., still a large portion of contiguous resources are available for PUSCH transmissions, given the parameters of BWPs for RedCap and non-RedCap UEs). For instance, if the size of non-RedCap BWP is considerably larger than the size of RedCap BWP and the RedCap BWP is located close to the edge of the non-RedCap BWP, the RedCap PUCCH frequency hopping may not cause a significant resource fragmentation, as illustrated in FIG. 5 (enabled RedCap PUCCH frequency hopping without significant PUSCH resource fragmentation (large contiguous frequency resources are available for PUSCH transmissions)).

In another embodiment, whether the PUCCH frequency hopping is enabled or disabled for RedCap UEs is determined based on a presence of one or more non-RedCap UEs in the cell. In some aspects, when no non-RedCap UE is present in the cell, the PUCCH frequency hopping may be enabled. This can be done dynamically via the downlink control information (DCI) that schedules Msg4/[MsgB]. For example, in time slots during which non-RedCap UEs are not scheduled, the PUCCH frequency hopping can be enabled for RedCap UEs.

The aforementioned embodiments can also be applicable to PUCCH transmissions after the initial access and/or when configuring non-initial BWPs.

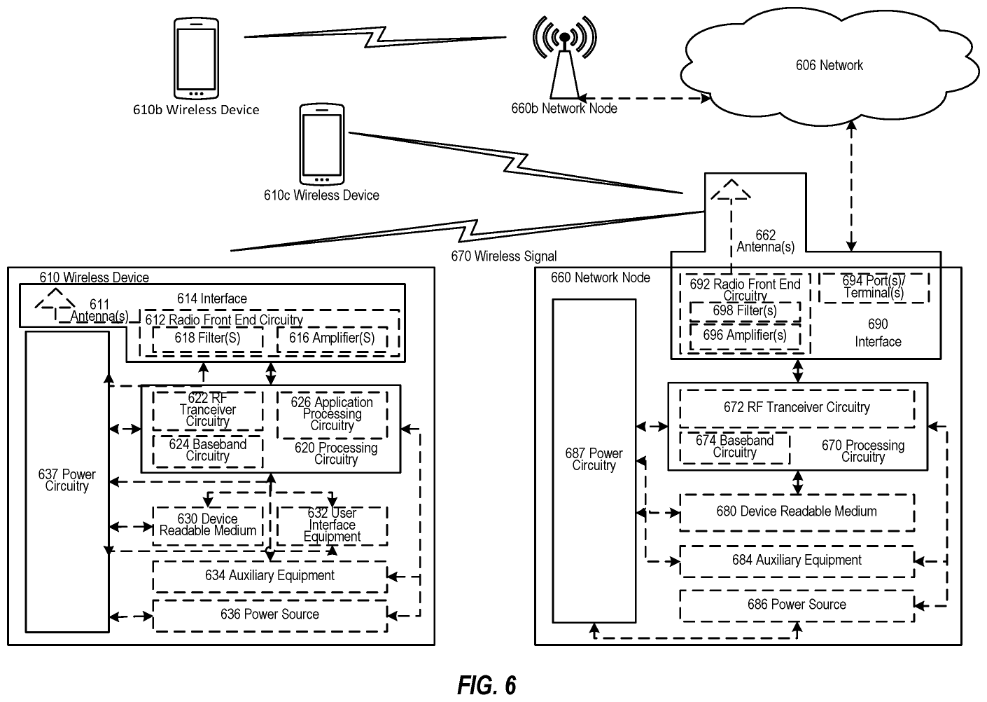

Although the subject matter described herein may be implemented in any appropriate type of system using any suitable components, the embodiments disclosed herein are described in relation to a wireless network, such as the example wireless network illustrated in FIG. 6. For simplicity, the wireless network of FIG. 6 only depicts network 606, network nodes 660 and 660b, and WDs 610, 610b, and 610c. In practice, a wireless network may further include any additional elements suitable to support communication between wireless devices or between a wireless device and another communication device, such as a landline telephone, a service provider, or any other network node or end device. Of the illustrated components, network node 660 and wireless device (WD) 610 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 606 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 660 and WD 610 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 6, network node 660 includes processing circuitry 670, device readable medium 680, interface 690, auxiliary equipment 684, power source 686, power circuitry 687, and antenna 662. Although network node 660 illustrated in the example wireless network of FIG. 6 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 660 are depicted as single boxes located within a larger box, or nested within multiple boxes, in practice, a network node may comprise multiple different physical components that make up a single illustrated component (e.g., device readable medium 680 may comprise multiple separate hard drives as well as multiple RAM modules).

Similarly, network node 660 may be composed of multiple physically separate components (e.g., a NodeB component and a RNC component, or a BTS component and a BSC component, etc.), which may each have their own respective components. In certain scenarios in which network node 660 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 660 may be configured to support multiple radio access technologies (RATs). In such embodiments, some components may be duplicated (e.g., separate device readable medium 680 for the different RATs) and some components may be reused (e.g., the same antenna 662 may be shared by the RATs). Network node 660 may also include multiple sets of the various illustrated components for different wireless technologies integrated into network node 660, such as, for example, GSM, WCDMA, LTE, NR, WiFi, or Bluetooth wireless technologies. These wireless technologies may be integrated into the same or different chip or set of chips and other components within network node 660.

Processing circuitry 670 is configured to perform any determining, calculating, or similar operations (e.g., certain obtaining operations) described herein as being provided by a network node. These operations performed by processing circuitry 670 may include processing information obtained by processing circuitry 670 by, for example, converting the obtained information into other information, comparing the obtained information or converted information to information stored in the network node, and/or performing one or more operations based on the obtained information or converted information, and as a result of said processing making a determination.

Processing circuitry 670 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 660 components, such as device readable medium 680, network node 660 functionality. For example, processing circuitry 670 may execute instructions stored in device readable medium 680 or in memory within processing circuitry 670. Such functionality may include providing any of the various wireless features, functions, or benefits discussed herein. In some embodiments, processing circuitry 670 may include a system on a chip (SOC).

In some embodiments, processing circuitry 670 may include one or more of radio frequency (RF) transceiver circuitry 672 and baseband processing circuitry 674. In some embodiments, radio frequency (RF) transceiver circuitry 672 and baseband processing circuitry 674 may be on separate chips (or sets of chips), boards, or units, such as radio units and digital units. In alternative embodiments, part or all of RF transceiver circuitry 672 and baseband processing circuitry 674 may be on the same chip or set of chips, boards, or units

In certain embodiments, some or all of the functionality described herein as being provided by a network node, base station, eNB or other such network device may be performed by processing circuitry 670 executing instructions stored on device readable medium 680 or memory within processing circuitry 670. In alternative embodiments, some or all of the functionality may be provided by processing circuitry 670 without executing instructions stored on a separate or discrete device readable medium, such as in a hard-wired manner. In any of those embodiments, whether executing instructions stored on a device readable storage medium or not, processing circuitry 670 can be configured to perform the described functionality. The benefits provided by such functionality are not limited to processing circuitry 670 alone or to other components of network node 660, but are enjoyed by network node 660 as a whole, and/or by end users and the wireless network generally.

Device readable medium 680 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 670. Device readable medium 680 may store any suitable instructions, data or information, including a computer program, software, an application including one or more of logic, rules, code, tables, etc. and/or other instructions capable of being executed by processing circuitry 670 and, utilized by network node 660. Device readable medium 680 may be used to store any calculations made by processing circuitry 670 and/or any data received via interface 690. In some embodiments, processing circuitry 670 and device readable medium 680 may be considered to be integrated.

Interface 690 is used in the wired or wireless communication of signalling and/or data between network node 660, network 606, and/or WDs 610. As illustrated, interface 690 comprises port(s)/terminal(s) 694 to send and receive data, for example to and from network 606 over a wired connection. Interface 690 also includes radio front end circuitry 692 that may be coupled to, or in certain embodiments a part of, antenna 662. Radio front end circuitry 692 comprises filters 698 and amplifiers 696. Radio front end circuitry 692 may be connected to antenna 662 and processing circuitry 670. Radio front end circuitry may be configured to condition signals communicated between antenna 662 and processing circuitry 670. Radio front end circuitry 692 may receive digital data that is to be sent out to other network nodes or WDs via a wireless connection. Radio front end circuitry 692 may convert the digital data into a radio signal having the appropriate channel and bandwidth parameters using a combination of filters 698 and/or amplifiers 696. The radio signal may then be transmitted via antenna 662. Similarly, when receiving data, antenna 662 may collect radio signals which are then converted into digital data by radio front end circuitry 692. The digital data may be passed to processing circuitry 670. In other embodiments, the interface may comprise different components and/or different combinations of components.

In certain alternative embodiments, network node 660 may not include separate radio front end circuitry 692, instead, processing circuitry 670 may comprise radio front end circuitry and may be connected to antenna 662 without separate radio front end circuitry 692. Similarly, in some embodiments, all or some of RF transceiver circuitry 672 may be considered a part of interface 690. In still other embodiments, interface 690 may include one or more ports or terminals 694, radio front end circuitry 692, and RF transceiver circuitry 672, as part of a radio unit (not shown), and interface 690 may communicate with baseband processing circuitry 674, which is part of a digital unit (not shown).

Antenna 662 may include one or more antennas, or antenna arrays, configured to send and/or receive wireless signals. Antenna 662 may be coupled to radio front end circuitry 690 and may be any type of antenna capable of transmitting and receiving data and/or signals wirelessly. In some embodiments, antenna 662 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 662 may be separate from network node 660 and may be connectable to network node 660 through an interface or port.

Antenna 662, interface 690, and/or processing circuitry 670 may be configured to perform any receiving operations and/or certain obtaining operations described herein as being performed by a network node. Any information, data and/or signals may be received from a wireless device, another network node and/or any other network equipment. Similarly, antenna 662, interface 690, and/or processing circuitry 670 may be configured to perform any transmitting operations described herein as being performed by a network node. Any information, data and/or signals may be transmitted to a wireless device, another network node and/or any other network equipment.

Power circuitry 687 may comprise, or be coupled to, power management circuitry and is configured to supply the components of network node 660 with power for performing the functionality described herein. Power circuitry 687 may receive power from power source 686. Power source 686 and/or power circuitry 687 may be configured to provide power to the various components of network node 660 in a form suitable for the respective components (e.g., at a voltage and current level needed for each respective component). Power source 686 may either be included in, or external to, power circuitry 687 and/or network node 660. For example, network node 660 may be connectable to an external power source (e.g., an electricity outlet) via an input circuitry or interface such as an electrical cable, whereby the external power source supplies power to power circuitry 687. As a further example, power source 686 may comprise a source of power in the form of a battery or battery pack which is connected to, or integrated in, power circuitry 687. The battery may provide backup power should the external power source fail. Other types of power sources, such as photovoltaic devices, may also be used.

Alternative embodiments of network node 660 may include additional components beyond those shown in FIG. 6 that may be responsible for providing certain aspects of the network node's functionality, including any of the functionality described herein and/or any functionality necessary to support the subject matter described herein. For example, network node 660 may include user interface equipment to allow input of information into network node 660 and to allow output of information from network node 660. This may allow a user to perform diagnostic, maintenance, repair, and other administrative functions for network node 660.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IOT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 610 includes antenna 611, interface 614, processing circuitry 620, device readable medium 630, user interface equipment 632, auxiliary equipment 634, power source 636 and power circuitry 637. WD 610 may include multiple sets of one or more of the illustrated components for different wireless technologies supported by WD 610, such as, for example, GSM, WCDMA, LTE, NR, WiFi, WiMAX, or Bluetooth wireless technologies, just to mention a few. These wireless technologies may be integrated into the same or different chips or set of chips as other components within WD 610.

Antenna 611 may include one or more antennas or antenna arrays, configured to send and/or receive wireless signals, and is connected to interface 614. In certain alternative embodiments, antenna 611 may be separate from WD 610 and be connectable to WD 610 through an interface or port. Antenna 611, interface 614, and/or processing circuitry 620 may be configured to perform any receiving or transmitting operations described herein as being performed by a WD. Any information, data and/or signals may be received from a network node and/or another WD. In some embodiments, radio front end circuitry and/or antenna 611 may be considered an interface.

As illustrated, interface 614 comprises radio front end circuitry 612 and antenna 611. Radio front end circuitry 612 comprise one or more filters 618 and amplifiers 616. Radio front end circuitry 614 is connected to antenna 611 and processing circuitry 620, and is configured to condition signals communicated between antenna 611 and processing circuitry 620. Radio front end circuitry 612 may be coupled to or a part of antenna 611. In some embodiments, WD 610 may not include separate radio front end circuitry 612; rather, processing circuitry 620 may comprise radio front end circuitry and may be connected to antenna 611. Similarly, in some embodiments, some or all of RF transceiver circuitry 622 may be considered a part of interface 614. Radio front end circuitry 612 may receive digital data that is to be sent out to other network nodes or WDs via a wireless connection. Radio front end circuitry 612 may convert the digital data into a radio signal having the appropriate channel and bandwidth parameters using a combination of filters 618 and/or amplifiers 616. The radio signal may then be transmitted via antenna 611. Similarly, when receiving data, antenna 611 may collect radio signals which are then converted into digital data by radio front end circuitry 612. The digital data may be passed to processing circuitry 620. In other embodiments, the interface may comprise different components and/or different combinations of components.

Processing circuitry 620 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 610 components, such as device readable medium 630, WD 610 functionality. Such functionality may include providing any of the various wireless features or benefits discussed herein. For example, processing circuitry 620 may execute instructions stored in device readable medium 630 or in memory within processing circuitry 620 to provide the functionality disclosed herein.

As illustrated, processing circuitry 620 includes one or more of RF transceiver circuitry 622, baseband processing circuitry 624, and application processing circuitry 626. In other embodiments, the processing circuitry may comprise different components and/or different combinations of components. In certain embodiments processing circuitry 620 of WD 610 may comprise a SOC. In some embodiments, RF transceiver circuitry 622, baseband processing circuitry 624, and application processing circuitry 626 may be on separate chips or sets of chips. In alternative embodiments, part or all of baseband processing circuitry 624 and application processing circuitry 626 may be combined into one chip or set of chips, and RF transceiver circuitry 622 may be on a separate chip or set of chips. In still alternative embodiments, part or all of RF transceiver circuitry 622 and baseband processing circuitry 624 may be on the same chip or set of chips, and application processing circuitry 626 may be on a separate chip or set of chips. In yet other alternative embodiments, part or all of RF transceiver circuitry 622, baseband processing circuitry 624, and application processing circuitry 626 may be combined in the same chip or set of chips. In some embodiments, RF transceiver circuitry 622 may be a part of interface 614. RF transceiver circuitry 622 may condition RF signals for processing circuitry 620.

In certain embodiments, some or all of the functionality described herein as being performed by a WD may be provided by processing circuitry 620 executing instructions stored on device readable medium 630, which in certain embodiments may be a computer-readable storage medium. In alternative embodiments, some or all of the functionality may be provided by processing circuitry 620 without executing instructions stored on a separate or discrete device readable storage medium, such as in a hard-wired manner. In any of those particular embodiments, whether executing instructions stored on a device readable storage medium or not, processing circuitry 620 can be configured to perform the described functionality. The benefits provided by such functionality are not limited to processing circuitry 620 alone or to other components of WD 610, but are enjoyed by WD 610 as a whole, and/or by end users and the wireless network generally.

Processing circuitry 620 may be configured to perform any determining, calculating, or similar operations (e.g., certain obtaining operations) described herein as being performed by a WD. These operations, as performed by processing circuitry 620, may include processing information obtained by processing circuitry 620 by, for example, converting the obtained information into other information, comparing the obtained information or converted information to information stored by WD 610, and/or performing one or more operations based on the obtained information or converted information, and as a result of said processing making a determination.

Device readable medium 630 may be operable to store a computer program, software, an application including one or more of logic, rules, code, tables, etc. and/or other instructions capable of being executed by processing circuitry 620. Device readable medium 630 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 620. In some embodiments, processing circuitry 620 and device readable medium 630 may be considered to be integrated.

User interface equipment 632 may provide components that allow for a human user to interact with WD 610. Such interaction may be of many forms, such as visual, audial, tactile, etc. User interface equipment 632 may be operable to produce output to the user and to allow the user to provide input to WD 610. The type of interaction may vary depending on the type of user interface equipment 632 installed in WD 610. For example, if WD 610 is a smart phone, the interaction may be via a touch screen; if WD 610 is a smart meter, the interaction may be through a screen that provides usage (e.g., the number of gallons used) or a speaker that provides an audible alert (e.g., if smoke is detected). User interface equipment 632 may include input interfaces, devices and circuits, and output interfaces, devices and circuits. User interface equipment 632 is configured to allow input of information into WD 610, and is connected to processing circuitry 620 to allow processing circuitry 620 to process the input information. User interface equipment 632 may include, for example, a microphone, a proximity or other sensor, keys/buttons, a touch display, one or more cameras, a USB port, or other input circuitry. User interface equipment 632 is also configured to allow output of information from WD 610, and to allow processing circuitry 620 to output information from WD 610. User interface equipment 632 may include, for example, a speaker, a display, vibrating circuitry, a USB port, a headphone interface, or other output circuitry. Using one or more input and output interfaces, devices, and circuits, of user interface equipment 632, WD 610 may communicate with end users and/or the wireless network, and allow them to benefit from the functionality described herein.

Auxiliary equipment 634 is operable to provide more specific functionality which may not be generally performed by WDs. This may comprise specialized sensors for doing measurements for various purposes, interfaces for additional types of communication such as wired communications etc. The inclusion and type of components of auxiliary equipment 634 may vary depending on the embodiment and/or scenario.

Power source 636 may, in some embodiments, be in the form of a battery or battery pack. Other types of power sources, such as an external power source (e.g., an electricity outlet), photovoltaic devices or power cells, may also be used. WD 610 may further comprise power circuitry 637 for delivering power from power source 636 to the various parts of WD 610 which need power from power source 636 to carry out any functionality described or indicated herein. Power circuitry 637 may in certain embodiments comprise power management circuitry. Power circuitry 637 may additionally or alternatively be operable to receive power from an external power source; in which case WD 610 may be connectable to the external power source (such as an electricity outlet) via input circuitry or an interface such as an electrical power cable. Power circuitry 637 may also in certain embodiments be operable to deliver power from an external power source to power source 636. This may be, for example, for the charging of power source 636. Power circuitry 637 may perform any formatting, converting, or other modification to the power from power source 636 to make the power suitable for the respective components of WD 610 to which power is supplied.

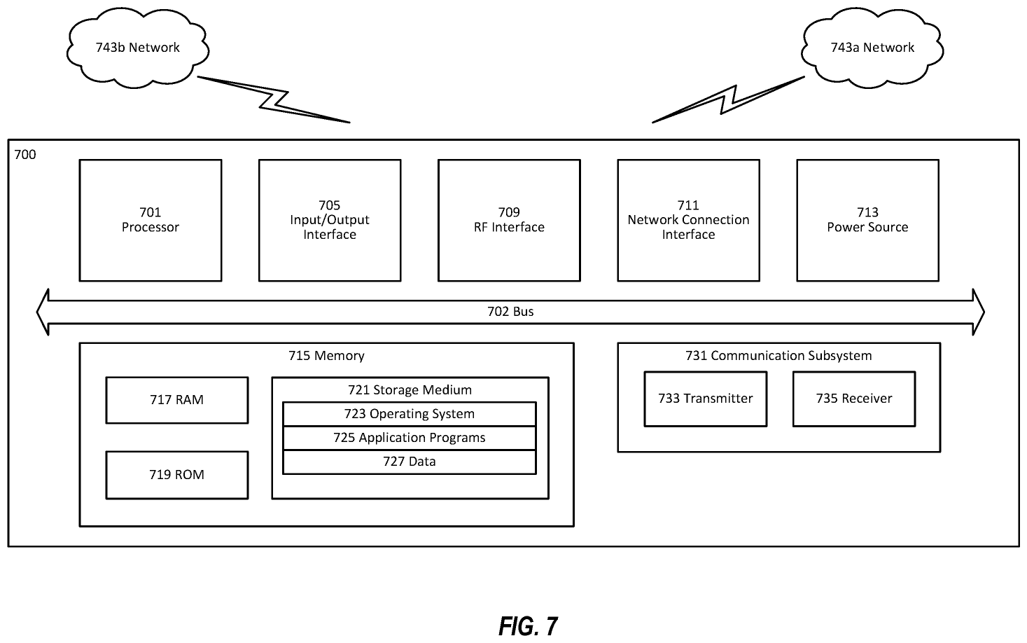

FIG. 7 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 7200 may be any UE identified by the 3rd Generation Partnership Project (3GPP), including a NB-IOT UE, a machine type communication (MTC) UE, and/or an enhanced MTC (eMTC) UE. UE 700, as illustrated in FIG. 7, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 7 is a UE, the components discussed herein are equally applicable to a WD, and vice-versa.

In FIG. 7, UE 700 includes processing circuitry 701 that is operatively coupled to input/output interface 705, radio frequency (RF) interface 709, network connection interface 711, memory 715 including random access memory (RAM) 717, read-only memory (ROM) 719, and storage medium 721 or the like, communication subsystem 731, power source 733, and/or any other component, or any combination thereof. Storage medium 721 includes operating system 723, application program 725, and data 727. In other embodiments, storage medium 721 may include other similar types of information. Certain UEs may utilize all of the components shown in FIG. 7, or only a subset of the components. The level of integration between the components may vary from one UE to another UE. Further, certain UEs may contain multiple instances of a component, such as multiple processors, memories, transceivers, transmitters, receivers, etc.

In FIG. 7, processing circuitry 701 may be configured to process computer instructions and data. Processing circuitry 701 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 701 may include two central processing units (CPUs). Data may be information in a form suitable for use by a computer.

In the depicted embodiment, input/output interface 705 may be configured to provide a communication interface to an input device, output device, or input and output device. UE 700 may be configured to use an output device via input/output interface 705. An output device may use the same type of interface port as an input device. For example, a USB port may be used to provide input to and output from UE 700. The output device may be a speaker, a sound card, a video card, a display, a monitor, a printer, an actuator, an emitter, a smartcard, another output device, or any combination thereof. UE 700 may be configured to use an input device via input/output interface 705 to allow a user to capture information into UE 700. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7, RF interface 709 may be configured to provide a communication interface to RF components such as a transmitter, a receiver, and an antenna. Network connection interface 711 may be configured to provide a communication interface to network 743a. Network 743a may encompass wired and/or wireless networks such as a local-area network (LAN), a wide-area network (WAN), a computer network, a wireless network, a telecommunications network, another like network or any combination thereof. For example, network 743a may comprise a Wi-Fi network. Network connection interface 711 may be configured to include a receiver and a transmitter interface used to communicate with one or more other devices over a communication network according to one or more communication protocols, such as Ethernet, TCP/IP, SONET, ATM, or the like. Network connection interface 711 may implement receiver and transmitter functionality appropriate to the communication network links (e.g., optical, electrical, and the like). The transmitter and receiver functions may share circuit components, software or firmware, or alternatively may be implemented separately.

RAM 717 may be configured to interface via bus 702 to processing circuitry 701 to provide storage or caching of data or computer instructions during the execution of software programs such as the operating system, application programs, and device drivers. ROM 719 may be configured to provide computer instructions or data to processing circuitry 701. For example, ROM 719 may be configured to store invariant low-level system code or data for basic system functions such as basic input and output (I/O), startup, or reception of keystrokes from a keyboard that are stored in a non-volatile memory. Storage medium 721 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 721 may be configured to include operating system 723, application program 725 such as a web browser application, a widget or gadget engine or another application, and data file 727. Storage medium 721 may store, for use by UE 700, any of a variety of various operating systems or combinations of operating systems.

Storage medium 721 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 721 may allow UE 700 to access computer-executable instructions, application programs or the like, stored on transitory or non-transitory memory media, to off-load data, or to upload data. An article of manufacture, such as one utilizing a communication system may be tangibly embodied in storage medium 721, which may comprise a device readable medium.

In FIG. 7, processing circuitry 701 may be configured to communicate with network 743b using communication subsystem 731. Network 743a and network 743b may be the same network or networks or different network or networks. Communication subsystem 731 may be configured to include one or more transceivers used to communicate with network 743b. For example, communication subsystem 731 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 733 and/or receiver 735 to implement transmitter or receiver functionality, respectively, appropriate to the RAN links (e.g., frequency allocations and the like). Further, transmitter 733 and receiver 735 of each transceiver may share circuit components, software or firmware, or alternatively may be implemented separately.

In the illustrated embodiment, the communication functions of communication subsystem 731 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 731 may include cellular communication, Wi-Fi communication, Bluetooth communication, and GPS communication. Network 743b may encompass wired and/or wireless networks such as a local-area network (LAN), a wide-area network (WAN), a computer network, a wireless network, a telecommunications network, another like network or any combination thereof. For example, network 743b may be a cellular network, a Wi-Fi network, and/or a near-field network. Power source 713 may be configured to provide alternating current (AC) or direct current (DC) power to components of UE 700.

The features, benefits and/or functions described herein may be implemented in one of the components of UE 700 or partitioned across multiple components of UE 700. Further, the features, benefits, and/or functions described herein may be implemented in any combination of hardware, software or firmware. In one example, communication subsystem 731 may be configured to include any of the components described herein. Further, processing circuitry 701 may be configured to communicate with any of such components over bus 702. In another example, any of such components may be represented by program instructions stored in memory that when executed by processing circuitry 701 perform the corresponding functions described herein. In another example, the functionality of any of such components may be partitioned between processing circuitry 701 and communication subsystem 731. In another example, the non-computationally intensive functions of any of such components may be implemented in software or firmware and the computationally intensive functions may be implemented in hardware.

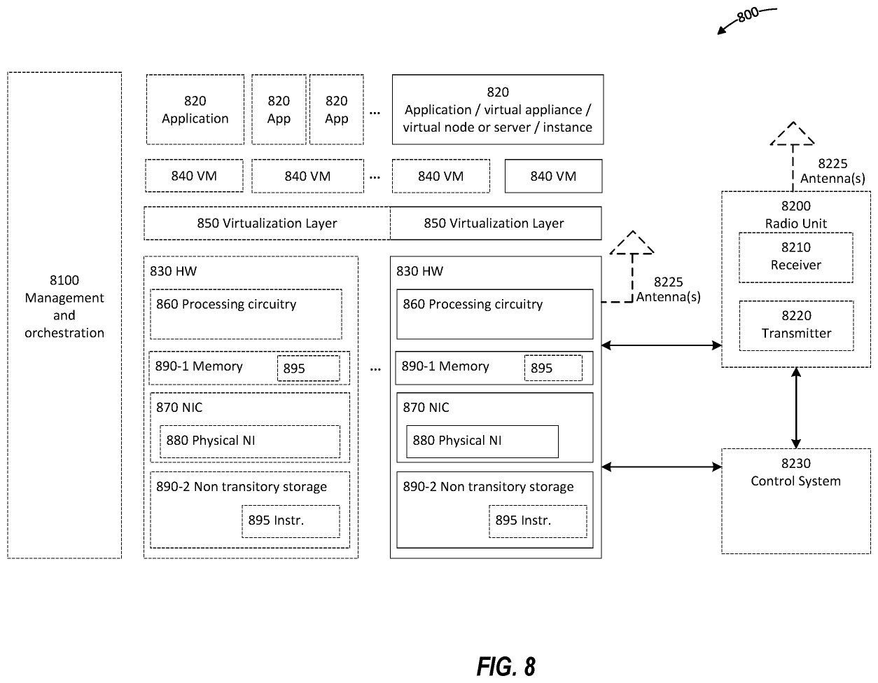

FIG. 8 is a schematic block diagram illustrating a virtualization environment 800 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 800 hosted by one or more of hardware nodes 830. Further, in embodiments in which the virtual node is not a radio access node or does not require radio connectivity (e.g., a core network node), then the network node may be entirely virtualized.

The functions may be implemented by one or more applications 820 (which may alternatively be called software instances, virtual appliances, network functions, virtual nodes, virtual network functions, etc.) operative to implement some of the features, functions, and/or benefits of some of the embodiments disclosed herein. Applications 820 are run in virtualization environment 800 which provides hardware 830 comprising processing circuitry 860 and memory 890. Memory 890 contains instructions 895 executable by processing circuitry 860 whereby application 820 is operative to provide one or more of the features, benefits, and/or functions disclosed herein.

Virtualization environment 800, comprises general-purpose or special-purpose network hardware devices 830 comprising a set of one or more processors or processing circuitry 860, which may be commercial off-the-shelf (COTS) processors, dedicated Application Specific Integrated Circuits (ASICs), or any other type of processing circuitry including digital or analog hardware components or special purpose processors. Each hardware device may comprise memory 890-1 which may be non-persistent memory for temporarily storing instructions 895 or software executed by processing circuitry 860. Each hardware device may comprise one or more network interface controllers (NICs) 870, also known as network interface cards, which include physical network interface 880. Each hardware device may also include non-transitory, persistent, machine-readable storage media 890-2 having stored therein software 895 and/or instructions executable by processing circuitry 860. Software 895 may include any type of software including software for instantiating one or more virtualization layers 850 (also referred to as hypervisors), software to execute virtual machines 840 as well as software allowing it to execute functions, features and/or benefits described in relation with some embodiments described herein.

Virtual machines 840, comprise virtual processing, virtual memory, virtual networking or interface and virtual storage, and may be run by a corresponding virtualization layer 850 or hypervisor. Different embodiments of the instance of virtual appliance 820 may be implemented on one or more of virtual machines 840, and the implementations may be made in different ways.

During operation, processing circuitry 860 executes software 895 to instantiate the hypervisor or virtualization layer 850, which may sometimes be referred to as a virtual machine monitor (VMM). Virtualization layer 850 may present a virtual operating platform that appears like networking hardware to virtual machine 840.

As shown in FIG. 8, hardware 830 may be a standalone network node with generic or specific components. Hardware 830 may comprise antenna 8225 and may implement some functions via virtualization. Alternatively, hardware 830 may be part of a larger cluster of hardware (e.g., such as in a data center or customer premise equipment (CPE)) where many hardware nodes work together and are managed via management and orchestration (MANO) 8100, which, among others, oversees lifecycle management of applications 820.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 840 may be a software implementation of a physical machine that runs programs as if they were executing on a physical, non-virtualized machine. Each of virtual machines 840, and that part of hardware 830 that executes that virtual machine, be it hardware dedicated to that virtual machine and/or hardware shared by that virtual machine with others of the virtual machines 840, forms a separate virtual network elements (VNE).

Still in the context of NFV, Virtual Network Function (VNF) is responsible for handling specific network functions that run in one or more virtual machines 840 on top of hardware networking infrastructure 830 and corresponds to application 820 in FIG. 8.

In some embodiments, one or more radio units 8200 that each include one or more transmitters 8220 and one or more receivers 8210 may be coupled to one or more antennas 8225. Radio units 8200 may communicate directly with hardware nodes 830 via one or more appropriate network interfaces and may be used in combination with the virtual components to provide a virtual node with radio capabilities, such as a radio access node or a base station.

In some embodiments, some signalling can be effected with the use of control system 8230 which may alternatively be used for communication between the hardware nodes 830 and radio units 8200.

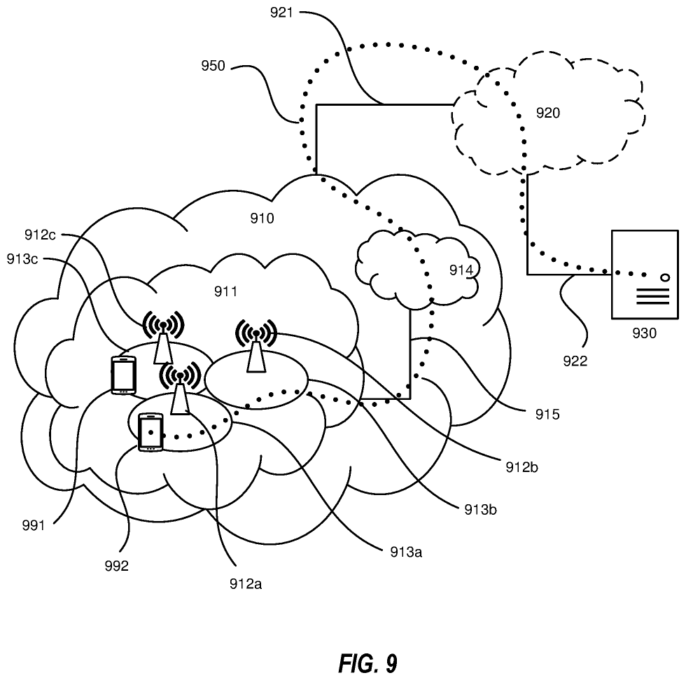

With reference to FIG. 9, in accordance with an embodiment, a communication system includes telecommunication network 910, such as a 3GPP-type cellular network, which comprises access network 911, such as a radio access network, and core network 914. Access network 911 comprises a plurality of base stations 912a, 912b, 912c, such as NBs, eNBs, gNBs or other types of wireless access points, each defining a corresponding coverage area 913a, 913b, 913c. Each base station 912a, 912b, 912c is connectable to core network 914 over a wired or wireless connection 915. A first UE 991 located in coverage area 913c is configured to wirelessly connect to, or be paged by, the corresponding base station 912c. A second UE 992 in coverage area 913a is wirelessly connectable to the corresponding base station 912a. While a plurality of UEs 991, 992 are illustrated in this example, the disclosed embodiments are equally applicable to a situation where a sole UE is in the coverage area or where a sole UE is connecting to the corresponding base station 912.

Telecommunication network 910 is itself connected to host computer 930, which may be embodied in the hardware and/or software of a standalone server, a cloud-implemented server, a distributed server or as processing resources in a server farm. Host computer 930 may be under the ownership or control of a service provider, or may be operated by the service provider or on behalf of the service provider. Connections 921 and 922 between telecommunication network 910 and host computer 930 may extend directly from core network 914 to host computer 930 or may go via an optional intermediate network 920. Intermediate network 920 may be one of, or a combination of more than one of, a public, private or hosted network; intermediate network 920, if any, may be a backbone network or the Internet; in particular, intermediate network 920 may comprise two or more sub-networks (not shown).

The communication system of FIG. 9 as a whole enables connectivity between the connected UEs 991, 992 and host computer 930. The connectivity may be described as an over-the-top (OTT) connection 950. Host computer 930 and the connected UEs 991, 992 are configured to communicate data and/or signaling via OTT connection 950, using access network 911, core network 914, any intermediate network 920 and possible further infrastructure (not shown) as intermediaries. OTT connection 950 may be transparent in the sense that the participating communication devices through which OTT connection 950 passes are unaware of routing of uplink and downlink communications. For example, base station 912 may not or need not be informed about the past routing of an incoming downlink communication with data originating from host computer 930 to be forwarded (e.g., handed over) to a connected UE 991. Similarly, base station 912 need not be aware of the future routing of an outgoing uplink communication originating from the UE 991 towards the host computer 930.

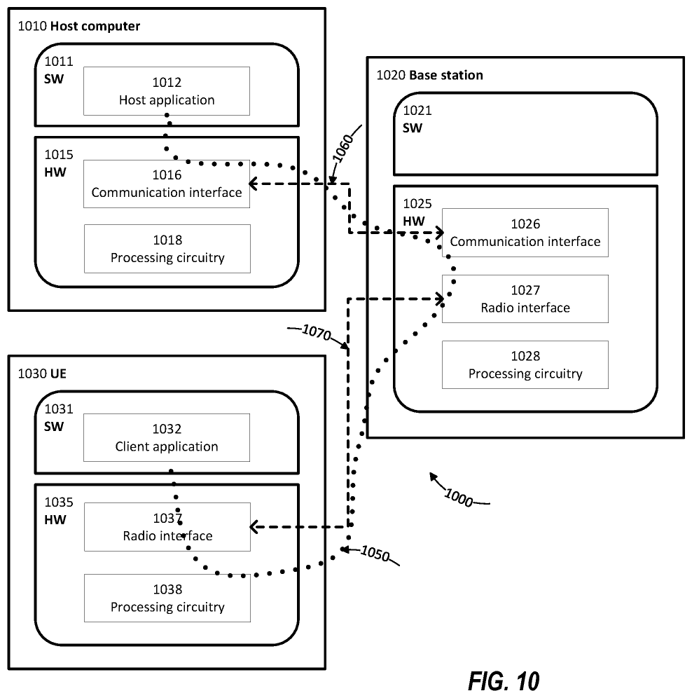

Example implementations, in accordance with an embodiment, of the UE, base station and host computer discussed in the preceding paragraphs will now be described with reference to FIG. 10. In communication system 1000, host computer 1010 comprises hardware 1015 including communication interface 1016 configured to set up and maintain a wired or wireless connection with an interface of a different communication device of communication system 1000. Host computer 1010 further comprises processing circuitry 1018, which may have storage and/or processing capabilities. In particular, processing circuitry 1018 may comprise one or more programmable processors, application-specific integrated circuits, field programmable gate arrays or combinations of these (not shown) adapted to execute instructions. Host computer 1010 further comprises software 1011, which is stored in or accessible by host computer 1010 and executable by processing circuitry 1018. Software 1011 includes host application 1012. Host application 1012 may be operable to provide a service to a remote user, such as UE 1030 connecting via OTT connection 1050 terminating at UE 1030 and host computer 1010. In providing the service to the remote user, host application 1012 may provide user data which is transmitted using OTT connection 1050.

Communication system 1000 further includes base station 1020 provided in a telecommunication system and comprising hardware 1025 enabling it to communicate with host computer 1010 and with UE 1030. Hardware 1025 may include communication interface 1026 for setting up and maintaining a wired or wireless connection with an interface of a different communication device of communication system 1000, as well as radio interface 1027 for setting up and maintaining at least wireless connection 1070 with UE 1030 located in a coverage area (not shown in FIG. 10) served by base station 1020. Communication interface 1026 may be configured to facilitate connection 1060 to host computer 1010. Connection 1060 may be direct or it may pass through a core network (not shown in FIG. 10) of the telecommunication system and/or through one or more intermediate networks outside the telecommunication system. In the embodiment shown, hardware 1025 of base station 1020 further includes processing circuitry 1028, which may comprise one or more programmable processors, application-specific integrated circuits, field programmable gate arrays or combinations of these (not shown) adapted to execute instructions. Base station 1020 further has software 1021 stored internally or accessible via an external connection.

Communication system 1000 further includes UE 1030 already referred to. Its hardware 1035 may include radio interface 1037 configured to set up and maintain wireless connection 1070 with a base station serving a coverage area in which UE 1030 is currently located. Hardware 1035 of UE 1030 further includes processing circuitry 1038, which may comprise one or more programmable processors, application-specific integrated circuits, field programmable gate arrays or combinations of these (not shown) adapted to execute instructions. UE 1030 further comprises software 1031, which is stored in or accessible by UE 1030 and executable by processing circuitry 1038. Software 1031 includes client application 1032. Client application 1032 may be operable to provide a service to a human or non-human user via UE 1030, with the support of host computer 1010. In host computer 1010, an executing host application 1012 may communicate with the executing client application 1032 via OTT connection 1050 terminating at UE 1030 and host computer 1010. In providing the service to the user, client application 1032 may receive request data from host application 1012 and provide user data in response to the request data. OTT connection 1050 may transfer both the request data and the user data. Client application 1032 may interact with the user to generate the user data that it provides.

It is noted that host computer 1010, base station 1020 and UE 1030 illustrated in FIG. 10 may be similar or identical to host computer 930, one of base stations 912a, 912b, 912c and one of UEs 991, 992 of FIG. 9, respectively. This is to say, the inner workings of these entities may be as shown in FIG. 10 and independently, the surrounding network topology may be that of FIG. 9.

In FIG. 10, OTT connection 1050 has been drawn abstractly to illustrate the communication between host computer 1010 and UE 1030 via base station 1020, without explicit reference to any intermediary devices and the precise routing of messages via these devices. Network infrastructure may determine the routing, which it may be configured to hide from UE 1030 or from the service provider operating host computer 1010, or both. While OTT connection 1050 is active, the network infrastructure may further take decisions by which it dynamically changes the routing (e.g., on the basis of load balancing consideration or reconfiguration of the network).

Wireless connection 1070 between UE 1030 and base station 1020 is in accordance with the teachings of the embodiments described throughout this disclosure. One or more of the various embodiments improve the performance of OTT services provided to UE 1030 using OTT connection 1050, in which wireless connection 1070 forms the last segment. More precisely, the teachings of these embodiments may improve the data rate, latency, power consumption, support PUCCH transmissions of reduced bandwidth UEs to efficiently coexist with regular UEs in a network, efficient support of UEs with different capabilities in a network, providing effective rules for efficiently enabling and disabling PUCCH frequency hopping, and/or enabling efficient resource utilization, avoiding resource fragmentation, enabling scheduling flexibility, and efficient utilization of network bandwidth/capacity and thereby provide benefits such as reduced user waiting time, relaxed restriction on a file size, better responsiveness, extended battery life, or the like.

A measurement procedure may be provided for the purpose of monitoring data rate, latency and other factors on which the one or more embodiments improve. There may further be an optional network functionality for reconfiguring OTT connection 1050 between host computer 1010 and UE 1030, in response to variations in the measurement results. The measurement procedure and/or the network functionality for reconfiguring OTT connection 1050 may be implemented in software 1011 and hardware 1015 of host computer 1010 or in software 1031 and hardware 1035 of UE 1030, or both. In embodiments, sensors (not shown) may be deployed in or in association with communication devices through which OTT connection 1050 passes; the sensors may participate in the measurement procedure by supplying values of the monitored quantities exemplified above, or supplying values of other physical quantities from which software 1011, 1031 may compute or estimate the monitored quantities. The reconfiguring of OTT connection 1050 may include message format, retransmission settings, preferred routing etc.; the reconfiguring need not affect base station 1020, and it may be unknown or imperceptible to base station 1020. Such procedures and functionalities may be known and practiced in the art. In certain embodiments, measurements may involve proprietary UE signaling facilitating host computer 1010's measurements of throughput, propagation times, latency and the like. The measurements may be implemented in that software 1011 and 1031 causes messages to be transmitted, in particular empty or ‘dummy’ messages, using OTT connection 1050 while it monitors propagation times, errors etc.

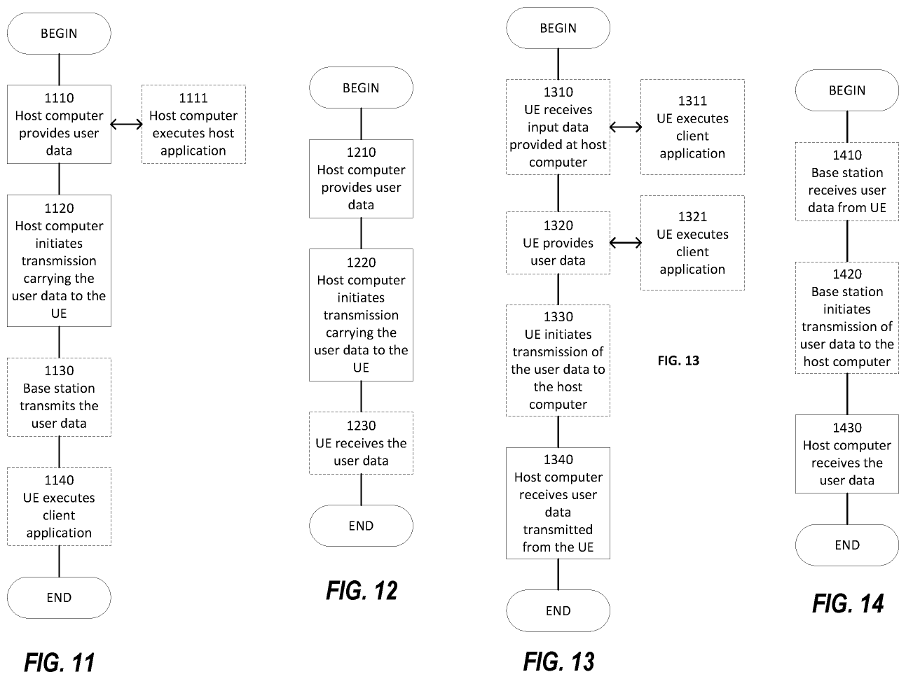

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this section. In step 1110, the host computer provides user data. In substep 1111 (which may be optional) of step 1110, the host computer provides the user data by executing a host application. In step 1120, the host computer initiates a transmission carrying the user data to the UE. In step 1130 (which may be optional), the base station transmits to the UE the user data which was carried in the transmission that the host computer initiated, in accordance with the teachings of the embodiments described throughout this disclosure. In step 1140 (which may also be optional), the UE executes a client application associated with the host application executed by the host computer.

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section. In step 1210 of the method, the host computer provides user data. In an optional substep (not shown) the host computer provides the user data by executing a host application. In step 1220, the host computer initiates a transmission carrying the user data to the UE. The transmission may pass via the base station, in accordance with the teachings of the embodiments described throughout this disclosure. In step 1230 (which may be optional), the UE receives the user data carried in the transmission.

FIG. 13 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section. In step 1310 (which may be optional), the UE receives input data provided by the host computer. Additionally, or alternatively, in step 1320, the UE provides user data. In substep 1321 (which may be optional) of step 1320, the UE provides the user data by executing a client application. In substep 1311 (which may be optional) of step 1310, the UE executes a client application which provides the user data in reaction to the received input data provided by the host computer. In providing the user data, the executed client application may further consider user input received from the user. Regardless of the specific manner in which the user data was provided, the UE initiates, in substep 1330 (which may be optional), transmission of the user data to the host computer. In step 1340 of the method, the host computer receives the user data transmitted from the UE, in accordance with the teachings of the embodiments described throughout this disclosure.

FIG. 14 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 14 will be included in this section. In step 1410 (which may be optional), in accordance with the teachings of the embodiments described throughout this disclosure, the base station receives user data from the UE. In step 1420 (which may be optional), the base station initiates transmission of the received user data to the host computer. In step 1430 (which may be optional), the host computer receives the user data carried in the transmission initiated by the base station.

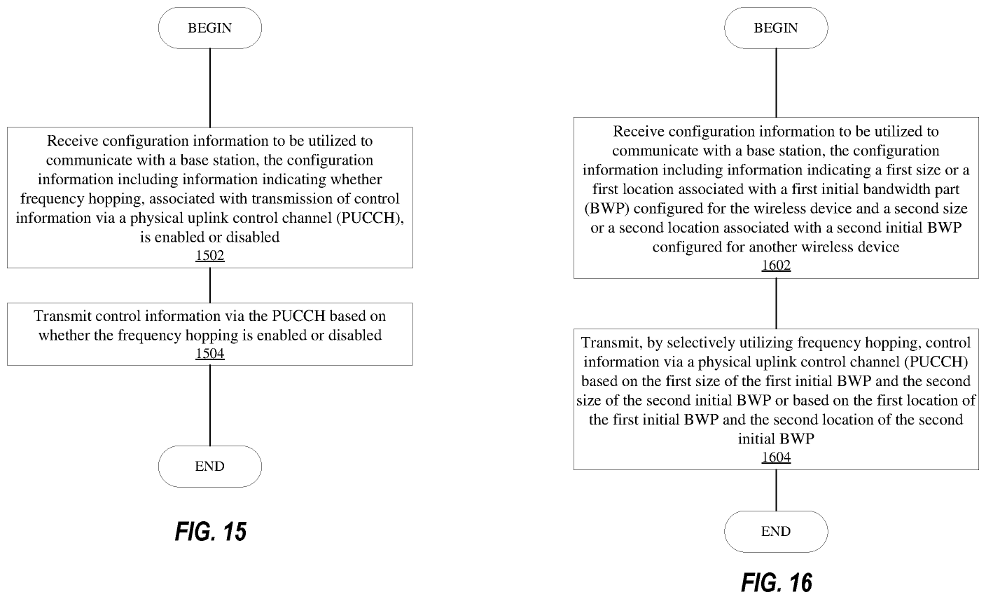

FIG. 15 depicts a flowchart of a method 1500 implemented by a wireless device in accordance with some embodiments. At step 1502, the wireless device receives configuration information to be utilized to communicate with a base station, the configuration information including information indicating whether frequency hopping, associated with transmission of control information via a physical uplink control channel (PUCCH), is enabled or disabled. At step 1504, the wireless device transmits control information via the PUCCH based on whether the frequency hopping is enabled or disabled. Other embodiments of the method 1500 may include other features as described herein.

FIG. 16 depicts a flowchart of a method 1600 implemented by a wireless device in accordance with some embodiments. At step 1602, the wireless device receives configuration information to be utilized to communicate with a base station, the configuration information including information indicating a first size or a first location associated with a first initial bandwidth part (BWP) configured for the wireless device and a second size or a second location associated with a second initial BWP configured for another wireless device. At step 1604, the wireless device transmits, by selectively utilizing frequency hopping, control information via a physical uplink control channel (PUCCH) based on the first size of the first initial BWP and the second size of the second initial BWP or based on the first location of the first initial BWP and the second location of the second initial BWP. Other embodiments of the method 1600 may include other features as described herein.

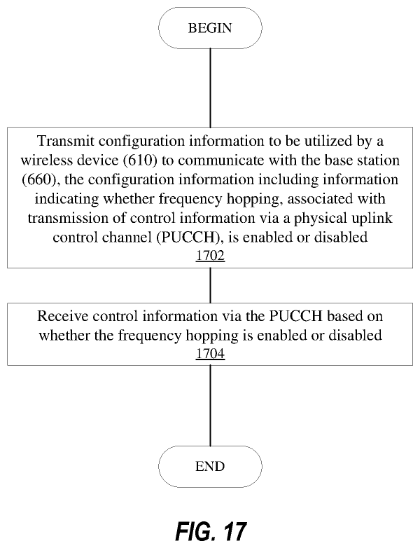

FIG. 17 depicts a flowchart of a method 1700 implemented by a base station in accordance with some embodiments. At step 1702, the network node transmits configuration information to be utilized by a wireless device to communicate with the base station, the configuration information including information indicating whether frequency hopping, associated with transmission of control information via a physical uplink control channel (PUCCH), is enabled or disabled. At step 1704, the base station receives control information via the PUCCH based on whether the frequency hopping is enabled or disabled. Other embodiments of the method 1700 may include other features as described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A method performed by a wireless device, the method comprising:
receiving configuration information to be utilized to communicate with a base station, the configuration information including information indicating whether frequency hopping, associated with transmission of control information via a physical uplink control channel (PUCCH), is enabled or disabled; and
transmitting control information via the PUCCH based on whether the frequency hopping is enabled or disabled.

2. The method of claim 1, wherein an information element included in a system information block of the configuration information indicates whether frequency hopping is enabled or disabled.

3. The method of claim 1, wherein receiving the configuration information, including the information indicating whether frequency hopping is enabled or disabled, includes receiving the configuration information dynamically.

4. The method of claim 1, further comprising:
transmitting the control information via the PUCCH by utilizing the frequency hopping when the frequency hopping is enabled; and
transmitting the control information via the PUCCH without utilizing the frequency hopping when the frequency hopping is disabled.

5. A method performed by a wireless device, the method comprising:
receiving configuration information to be utilized to communicate with a base station, the configuration information including information indicating a first size or a first location associated with a first initial bandwidth part (BWP) configured for the wireless device and a second size or a second location associated with a second initial BWP configured for another wireless device; and
transmitting, by selectively utilizing frequency hopping, control information via a physical uplink control channel (PUCCH) based on the first size of the first initial BWP and the second size of the second initial BWP or based on the first location of the first initial BWP and the second location of the second initial BWP.

6. The method of claim 5, wherein the wireless device transmits the control information via the PUCCH by utilizing the frequency hopping when the first size and the second size are substantially the same.

7. The method of claim 5, wherein the wireless device transmits the control information via the PUCCH without utilizing the frequency hopping when the first size and the second size are different.

8. The method of claim 5, wherein the wireless device transmits the control information via the PUCCH without utilizing the frequency hopping when the first initial BWP is located within the second initial BWP.

9. The method of claim 5, wherein whether the frequency hopping is enabled or disabled is based on a presence of another wireless device in a cell associated with the base station.

10. The method of claim 5, further comprising:
providing user data; and
forwarding the user data to a host computer via a transmission to the base station.

11. A method performed by a base station, the method comprising:
transmitting configuration information to be utilized by a wireless device to communicate with the base station, the configuration information including information indicating whether frequency hopping, associated with transmission of control information via a physical uplink control channel (PUCCH), is enabled or disabled; and
receiving control information via the PUCCH based on whether the frequency hopping is enabled or disabled.

12. The method of claim 9, wherein an information element included in a system information block of the configuration information indicates whether the frequency hopping is enabled or disabled.

13. The method of claim 9, wherein transmitting the configuration information, including the information indicating whether the frequency hopping is enabled or disabled, includes transmitting the configuration information dynamically.

14. The method of claim 11, further comprising:
obtaining user data; and
forwarding the user data to a host computer or a wireless device.

15. A wireless device comprising:
processing circuitry configured to perform operations comprising:
receiving configuration information to be utilized to communicate with a base station, the configuration information including information indicating whether frequency hopping, associated with transmission of control information via a physical uplink control channel, is enabled or disabled; and
transmitting control information via the PUCCH based on whether the frequency hopping is enabled or disabled; and
power supply circuitry configured to supply power to the wireless device.

16-46. (canceled)

47. The wireless device of claim 15, wherein an information element included in a system information block of the configuration information indicates whether frequency hopping is enabled or disabled.

48. The wireless device of claim 15, wherein receiving the configuration information, including the information indicating whether frequency hopping is enabled or disabled, includes receiving the configuration information dynamically.

49. The wireless device of claim 15, further comprising:
transmitting the control information via the PUCCH by utilizing the frequency hopping when the frequency hopping is enabled; and
transmitting the control information via the PUCCH without utilizing the frequency hopping when the frequency hopping is disabled.
